(19) United States
(12) Patent Application Publication
(10) Pub. No.: US 2008/0121480 A1
(43) Pub. Date: May 29, 2008

(54) Ejector and negative pressure supply apparatus for brake booster using the ejector

(75) Inventors: Yutaka Kawamori, Obu-shi (JP); Tsutomu Nishitani, Nagoya-shi (JP); Yoshiki Ito, Nagoya-shi (JP); Kiyoshi Tsukiji, Chita-gun (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, Obu-Shi (JP)

(21) Appl. No.: 11/976,412

(22) Filed: Oct. 24, 2007

(30) Foreign Application Priority Data
Nov. 23, 2006 (JP) 2006-316382

(51) Int. Cl. B60T 11/00

(52) U.S. Cl. 188/356

(57) ABSTRACT

An ejector including a nozzle communicating with a fluid inlet, a diffuser communicating with a fluid outlet, and a decompression chamber placed between the nozzle and he diffuser. The ejector is arranged to generate a negative pressure in the decompression chamber by a fluid ejected from the nozzle. A target negative pressure P in the decompression chamber is set in a range of “40 kPa<P≦50 kPa”. A SD/Sd ratio between a sectional area SD of an inlet of the diffuser and a sectional area Sd of an outlet of the nozzle is determined to meet a relation:

“1.20≦SD/Sd≦4.08−0.047P”.

### BACKGROUND OF THE INVENTION

1. Field of the Invention

The present invention relates to an ejector for generating a negative pressure and a negative pressure supply apparatus using the ejector. More particularly, the present invention relates to an ejector arranged to rapidly generate a target negative pressure and a negative pressure supply apparatus for brake booster, using the ejector.

2. Description of Related Art

Heretofore, an ejector has been utilized for generating a negative pressure. This ejector is arranged to generate a negative pressure by air ejected from a nozzle. To improve performance of the ejector, various techniques have been proposed. One of the techniques is for example to design a throat with a diameter larger at a predetermined ratio than a diameter of the nozzle and set a predetermined distance between the nozzle and the throat, thereby improving the ejector performance (Japanese Unexamined Utility Model Publication No. 62-112000(1987).

As a negative pressure supply apparatus using the ejector, for example, there is a negative pressure supply apparatus for brake booster arranged to supply a negative pressure to a brake booster attached to a brake master cylinder constituting a braking system of a vehicle. This type of negative pressure supply apparatus includes a nozzle connected to an air inlet port, a diffuser connected to of an air outlet, and a decompression chamber located between the nozzle and diffuser. A negative pressure generated by air ejected from the nozzle is allowed to flow from the decompression chamber into the brake booster (Japanese Unexamined Patent Publication No. 2005-171925).

However, the aforementioned ejector and negative pressure supply apparatus for brake booster have no clear specifications or data for allowing a predetermined large (high) negative pressure to be generated in a short operating time (with high response). In other words, the above publication has no disclosure about the ejector and the negative pressure supply apparatus capable of generating a predetermined large negative pressure in a short operating time. Thus, the above ejector and the negative pressure supply apparatus for brake booster could not generate a predetermined large negative pressure in a short operating time.

In particular, there is an increasing demand for the negative pressure supply apparatus for brake booster capable of setting as large (high) a target negative pressure as possible and shortening the time required to obtain the target negative pressure.

### BRIEF SUMMARY OF THE INVENTION

The present invention has an object to provide an ejector capable of generating a predetermined large (high) negative pressure in a short operating time and a negative pressure supply apparatus for brake booster using the ejector.

To achieve the above object, the present invention according to one aspect provides an ejector for generating a negative pressure, including: a nozzle communicating with a fluid inlet; a diffuser communicating with a fluid outlet; and a decompression chamber placed between the nozzle and the diffuser; wherein the ejector is arranged to generate the negative pressure in the decompression chamber by a fluid ejected from the nozzle, a target pressure P in the decompression chamber is set in a range of “40 kPa<P≦50 kPa”, and an SD/Sd ratio between a sectional area SD of an inlet of the diffuser and a sectional area Sd of an outlet of the nozzle is determined to satisfy a relation:

“1.20≦SD/Sd≦4.08−0.047P”.

According to another aspect, the present invention provides an ejector for generating a negative pressure, including: a nozzle communicating with a fluid inlet; a diffuser communicating with a fluid outlet; and a decompression chamber placed between the nozzle and the diffuser; wherein the ejector is arranged to generate the negative pressure in the decompression chamber by a fluid ejected from the nozzle, a target pressure P in the decompression chamber is set in a range of “40 kPa<P≦50 kPa”, and an SD/Sd ratio between a sectional area SD of an inlet of the diffuser and a sectional area Sd of an outlet of the nozzle is determined to satisfy a relation:

“1.25≦SD/Sd≦4.2−0.05P”.

Further, according to another aspect, the present invention provides an ejector for generating a negative pressure, including: a nozzle communicating with a fluid inlet; a diffuser communicating with a fluid outlet; and a decompression chamber placed between the nozzle and the diffuser; wherein the ejector is arranged to generate the negative pressure in the decompression chamber by a fluid ejected from the nozzle, a target pressure P in the decompression chamber is set to 40 kPa or lower, and an SD/Sd ratio between a sectional area SD of an inlet of the diffuser and a sectional area Sd of an outlet of the nozzle is determined to satisfy a relation: “1.25≦SD/Sd≦2.2”.

According to another aspect, furthermore, the present invention provided a negative pressure supply apparatus for brake booster for supplying a negative pressure to a brake booster mounted in a vehicle, wherein the supply apparatus includes the aforementioned ejector, and the decompression chamber can be communicated with the brake booster.

### BRIEF DESCRIPTION OF THE DRAWINGS

In the drawings,

FIG. 1 is a sectional view showing a schematic configuration of an ejector of a preferred embodiment;

FIG. 2 is an enlarged view of a part A circled with a dashed line in FIG. 1;

FIG. 3 is a graph showing a relation between a “SD/Sd” ratio and a time-to-target negative pressure for a target negative pressure of 30 kPa;

FIG. 4 is a graph showing a relation between the “SD/Sd” ratio and the time-to-target negative pressure for a target negative pressure of 40 kPa;

FIG. 5 is a graph showing a relation between the “SD/Sd” ratio and the time-to-target negative pressure for a target negative pressure of 45 kPa;

FIG. 6 is a graph showing a relation between the “SD/Sd” ratio and the time-to-target negative pressure for a target negative pressure of 50 kPa;

FIG. 7 is a graph showing a relation between an “L/d” ratio and a time-to-target negative pressure for a target negative pressure of 30 kPa;

FIG. 8 is a graph showing a relation between the “L/d” ratio and the time-to-target negative pressure for a target negative pressure of 40 kPa;

FIG. 9 is a graph showing a relation between the “L/d” ratio and the time-to-target negative pressure for a target negative pressure of 45 kPa;

FIG. 10 is a graph showing a relation between the “L/d” ratio and the time-to-target negative pressure for a target negative pressure of 50 kPa;

FIG. 11 is a schematic configuration view of a negative pressure supply apparatus for brake booster of the present embodiment;

FIG. 12 is a plan view showing the shape of a valve chamber of an opening and closing valve;

FIG. 13 is a sectional view showing a schematic configuration of the opening and closing valve (in a valve-open state) during an engine cold period;

FIG. 14 is a sectional view showing a schematic configuration of the opening and closing valve (in a valve-closed state) during an engine warm-up period;

FIG. 15 is an external view of a throttle valve control apparatus in which the negative pressure supply apparatus for brake booster is integrally assembled; and

FIG. 16 is a partially sectional view of the throttle valve control apparatus of FIG. 15.

### DETAILED DESCRIPTION OF THE PREFERRED EMBODIMENTS

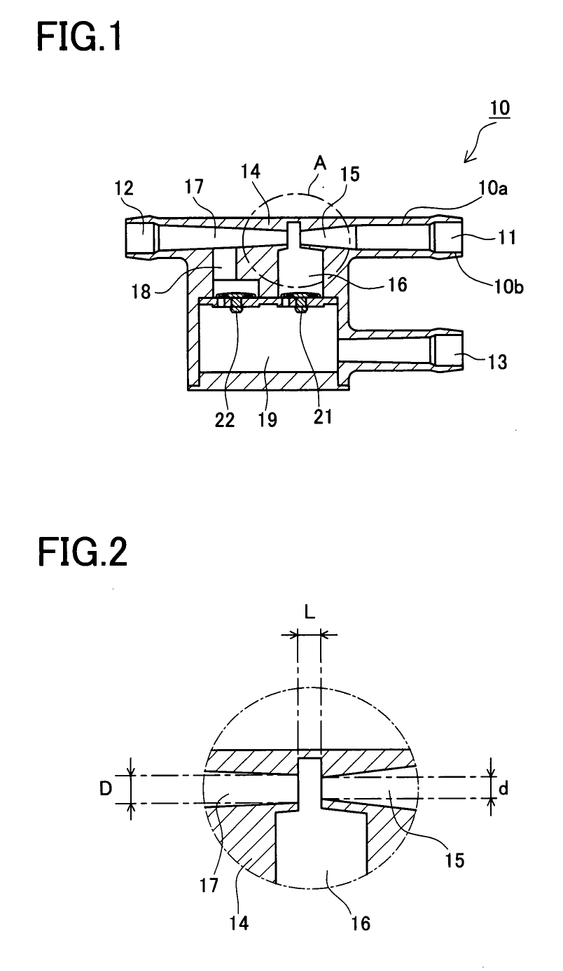

A detailed description of a preferred embodiment of an ejector embodying the present invention will now be given referring to the accompanying drawings. This ejector of the present embodiment will be explained referring to FIGS. 1 and 2. FIG. 1 is a sectional view showing a schematic configuration of the ejector of the present embodiment. FIG. 2 is an enlarged view of a part A circled with a dashed line in FIG. 1.

Referring to FIG. 1, an ejector 10 includes a housing 14 formed with an inlet port 11 through which a fluid will flow in the ejector 10, an outlet port 12 through which the fluid will flow out of the ejector 10, and a joint port 13 which will be coupled to an object to be supplied with a negative pressure. The housing 14 is further formed with a nozzle 15, a decompression chamber 16, a diffuser 17, a communication passage 18, and a suction chamber 19 in addition to the inlet port 11, the outlet port 12, and the joint port 13.

The nozzle 15 is configured to communicate with the inlet port 11 and have a tapered inner wall so that a cross sectional area gradually decreases in a direction opposite the inlet port 11 to raise the velocity of flow flowing in the nozzle 15 trough the inlet port 11. This nozzle 15 communicates with one end of the diffuser 17 via the decompression chamber 16.

The diffuser 17 is configured to have a tapered inner wall, but tapered reversely from the nozzle 15, so that a passage sectional area gradually increases in a direction toward the outlet port 12 to reduce flow loss of fluid ejected from the nozzle 15 for preventing a decrease in flow velocity of the fluid in the nozzle 15. The other end of this diffuser 17 communicates with the outlet port 12. The fluid flowing in the ejector 10 through the inlet port 11 is allowed to pass through the nozzle 15, part of the decompression chamber 16 (a communicating portion between the nozzle 15 and the diffuser 17), and the diffuser 17 to flow out through the outlet port 12.

The decompression chamber 16 communicates with the nozzle 15 and the diffuser 17, while it is connected to the suction chamber 19 via a first check valve 21. The suction chamber 19 is also connected to the communication passage 18 via a second check valve 22. This suction chamber 19 communicates with the joint port 13.

In the above ejector 10, when a fluid flows therein through the inlet port 11, the flow of this fluid passing through the nozzle 15 generates a negative pressure in the decompression chamber 16, causing the first check valve 21 to open. Accordingly, the negative pressure generated in the decompression chamber 16 is introduced from the decompression chamber 16, via the suction chamber 19 and the joint port 13, to an object to be supplied with the negative pressure.

To shorten the time required to reach a target negative pressure (herein, referred to as a “time-to-target negative pressure”), the inventors of the present invention have found out through experiment that a relation (SD/Sd) between a sectional area SD of an entrance of the diffuser and a sectional area Sd of an outlet of the nozzle has only to be adjusted to an optimum ratio. The ejector 10 of the present embodiment is therefore arranged to satisfy a relation that an SD/Sd ratio of the inlet sectional area SD (inlet diameter D) of the diffuser to the outlet sectional area Sd (outlet diameter d) of the nozzle 15 in FIG. 2 is “1.20≦SD/Sd≦4.08−0.047P”, where P denotes a target negative pressure to be generated in the decompression chamber 16 and is set in a range of “40 kPa<P≦50 kPa”.

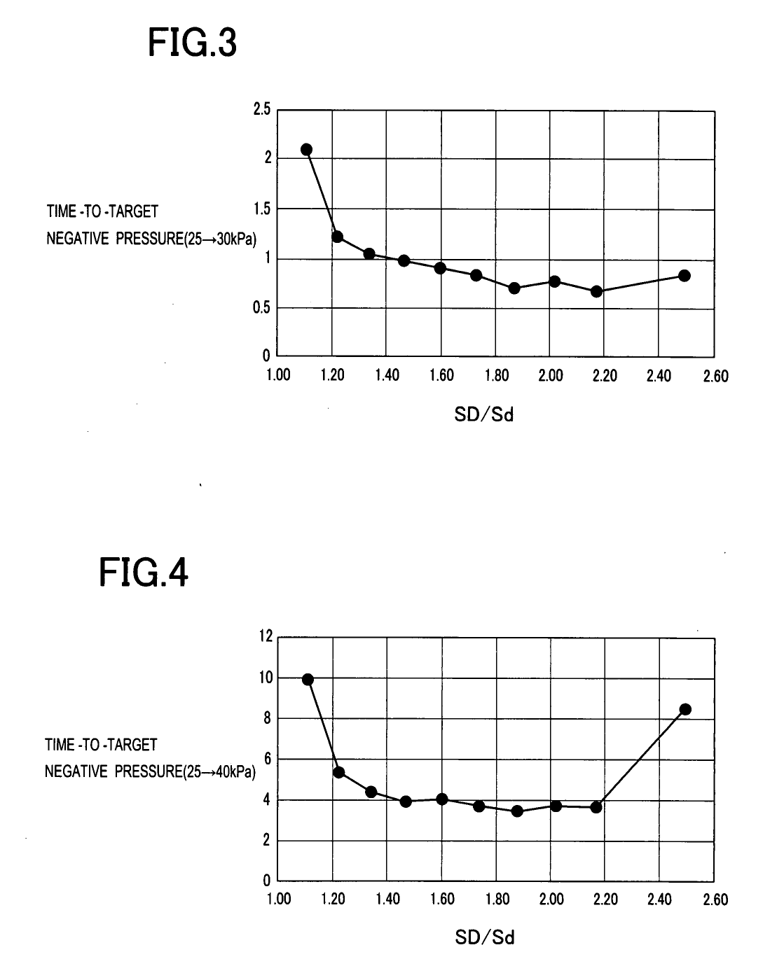

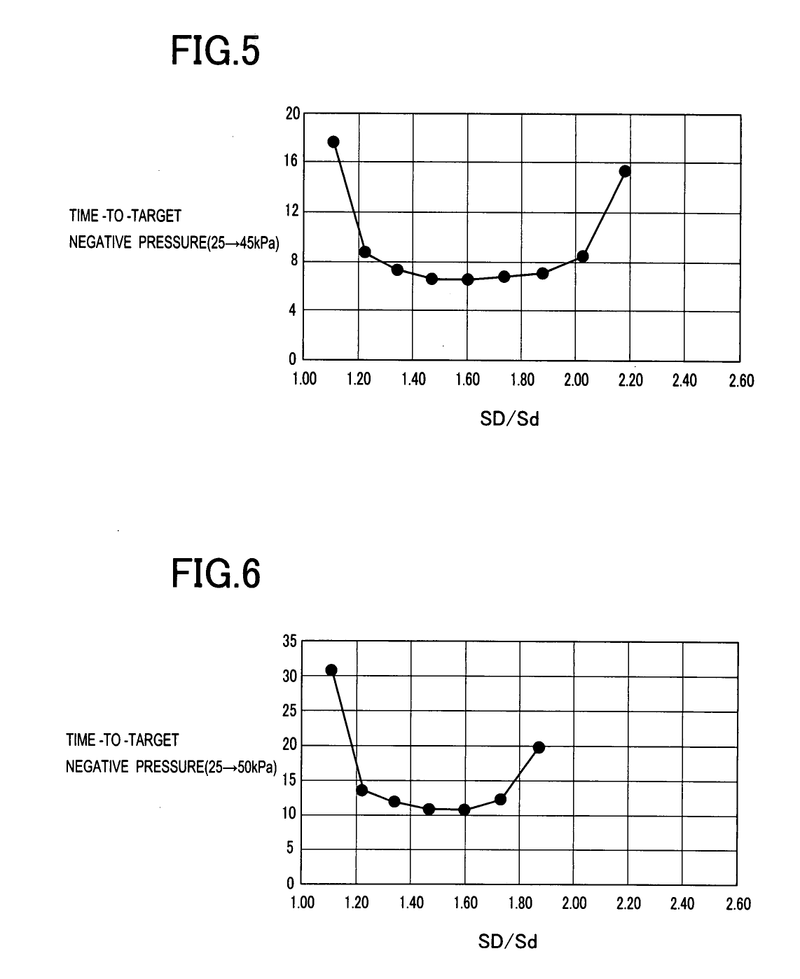

Here, FIGS. 3 to 6 show measuring results as to the time required to reach the target negative pressure P (the time-to-target negative pressure) from an operation start of each of the ejectors 10 with different SD/Sd ratios. This time-to-target negative pressure is a time needed until a negative pressure set at 25 kPa in an initial state reaches the target negative pressure. FIG. 3 is a graph showing a relation between the SD/Sd ratio and the time-to-target negative pressure for a target negative pressure of 30 kPa; FIG. 4 is a graph showing a relation between the SD/Sd ratio and the time-to-target negative pressure for a target negative pressure of 40 kPa; FIG. 5 is a graph showing a relation between the SD/Sd ratio and the time-to-target negative pressure for a target negative pressure of 45 kPa; and FIG. 6 is a graph showing a relation between the SD/Sd ratio and the time-to-target negative pressure for a target negative pressure of 50 kPa;

As can be seen from FIG. 3, when the SD/Sd ratio is lower than 1.25, it takes an extremely longer time to reach the target negative pressure. When the SD/Sd ratio is larger than 2.2, similarly, it takes an extremely longer time to reach the target negative pressure. Those results show that the SD/Sd ratio for the target negative pressure P of 30 kPa is preferably set in a range of “1.20≦SD/Sd≦2.2” in order to shorten the time-to-target negative pressure. Accordingly, the time-to-target negative pressure can be shortened to 4 seconds (in a prior art, about 5 seconds).

As is evident from FIG. 4, when the SD/Sd ratio is lower than 1.2, it takes an extremely longer time to reach the target negative pressure. When the SD/Sd ratio is larger than 2.2, similarly, it takes an extremely longer time to reach the target negative pressure. Those results show that the SD/Sd ratio for the target negative pressure P of 40 kPa is preferably set in a range of “1.20≦SD/Sd≦2.2” in order to shorten the time-to-target negative pressure. Accordingly, the time-to-target negative pressure can be shortened to about 4 seconds (in a prior art, about 5 seconds).

As shown in FIG. 5, when the SD/Sd ratio is lower than 1.2, it takes an extremely longer time to reach the target negative pressure. When the SD/Sd ratio is larger than 2.0, similarly, it takes an extremely longer time to reach the target negative pressure. Those results indicate that the SD/Sd ratio for the target negative pressure P of 45 kPa is preferably set in a range of “1.20≦SD/Sd≦2.0” in order to shorten the time-to-target negative pressure. Accordingly, the time-to-target negative pressure can be shortened to about 7 seconds (in a prior art, about 8 seconds).

As can be seen from FIG. 6, when the SD/Sd ratio is lower than 1.2, it takes an extremely longer time to reach the target negative pressure. When the SD/Sd ratio is larger than 1.75, similarly, it takes an extremely longer time to reach the target negative pressure. Those results show that the SD/Sd ratio for the target negative pressure P of 50 kPa is preferably set in a range of “1.20≦SD/Sd≦1.75” in order to shorten the time-to-target negative pressure. Accordingly, the time-to-target negative pressure can be shortened to about 12 seconds (in a prior art, about 13 seconds).

Since the target negative pressure P in the decompression chamber 16 is set in the range of “40 kPa≦P≦50 kPa”, focusing attention to FIGS. 4 to 6, when the SD/Sd ratio is lower than 1.2, the time required to reach the target negative pressure set in the range of “40 kPa<P≦50 kPa” is extremely longer. Accordingly, when the lower limit of the SD/Sd ratio is set at 1.2, the time to reach the target negative pressure can be shortened as clearly shown in FIGS. 4 to 6.

As for the upper limit of the SD/Sd ratio, on the other hand, the SD/Sd ratio is “2.2”, “2.0”, and “1.75” which are smaller with respect to the target negative pressure larger in the range of “40 kPa<P≦50 kPa” as shown in FIGS. 4 to 6. Accordingly, the upper limit of the SD/Sd ratio whereby the time required to reach the target negative pressure is shortened can be determined by linearly approximating those relations between the SD/Sd ratio and the target negative pressure P. In the present embodiment, in relation to the target negative pressure of “40 kPa<P≦50 kPa”, the upper limit of the SD/Sd ratio is set to “1.20≦SD/Sd≦4.08−0.047P”. Thus, the SD/Sd is 2.2 for 40 kPa of the target negative pressure P, 1.965 for 45 kPa of the target negative pressure P, and 1.73 for 50 kPa of the target negative pressure P. Consequently, by setting the upper limit of the SD/Sd to a value of “1.20≦SD/Sd≦4.08−0.047P”, it is possible to shorten the time required to reach the target negative pressure as seen in FIGS. 4 to 6.

A preferable range of the SD/SD is “1.25≦SD/Sd≦4.2−0.05P”, because the ejector designed with such a numerical SD/Sd range can further shorten the time-to-target negative pressure.

As above, the ejector is designed with the SD/Sd ratio set in the range of “1.20≦SD/Sd≦4.08−0.047P”, so that the target negative pressure can be generated in a short time even where the target negative pressure P to be generated in the decompression chamber is as large as “40 kPa<P≦50 kPa”.

If the target negative pressure P to be generated in the decompression chamber is set to be 40 kPa or lower (P≦40 kPa), as shown in FIGS. 3 and 4, the optimum SD/Sd range is fixed without varying depending on the target negative pressure P. To be specific, it is found that, irrespective of a level of the target negative pressure, the time-to-target negative pressure is longer in both the cases where the SD/Sd ratio is lower than 1.25 and where the SD/Sd ratio is more than 2.2. When the target negative pressure P in the decompression chamber is set at 40 kPa or lower, the numerical range of the SD/Sd ratio is set to “1.25≦SD/Sd≦2.2”, so that the target negative pressure P can be obtained in a short operating time.

Moreover, to shorten the time-to-target negative pressure, the inventors of the present invention also have found out through experiment that it is necessary to optimize a ratio L/d of the distance L between the outlet of the nozzle 15 and the inlet of the diffuser 17 to the outlet diameter d of the nozzle 15. The ejector 10 of the present embodiment is therefore designed with the L/d ratio satisfying the relation “0.50≦L/d≦1.50”.

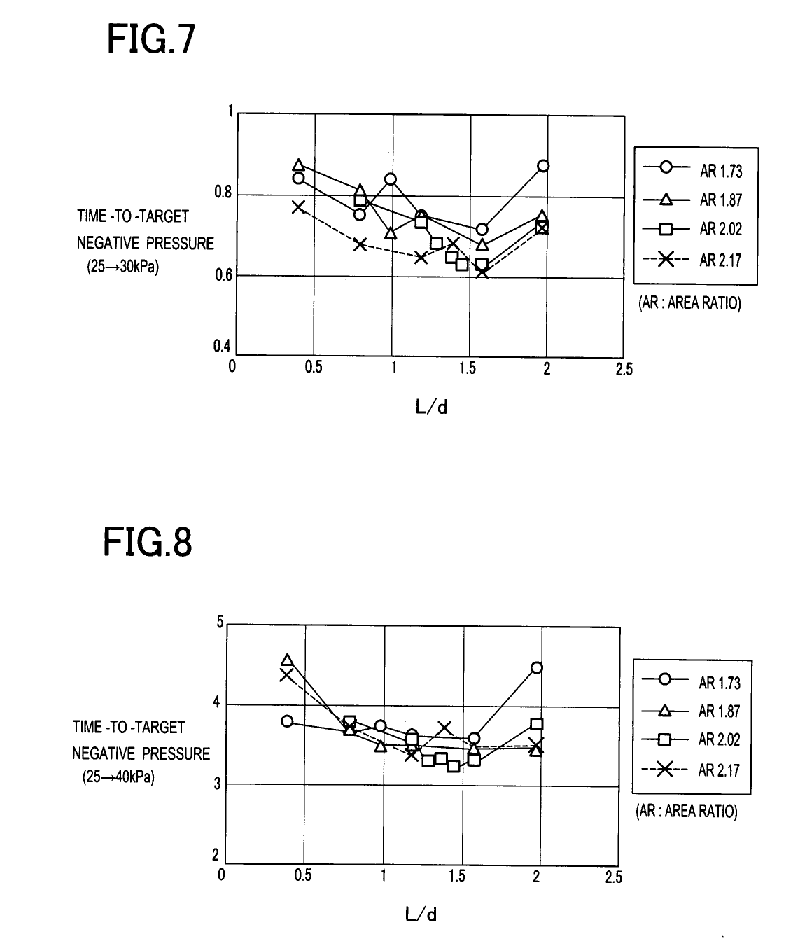

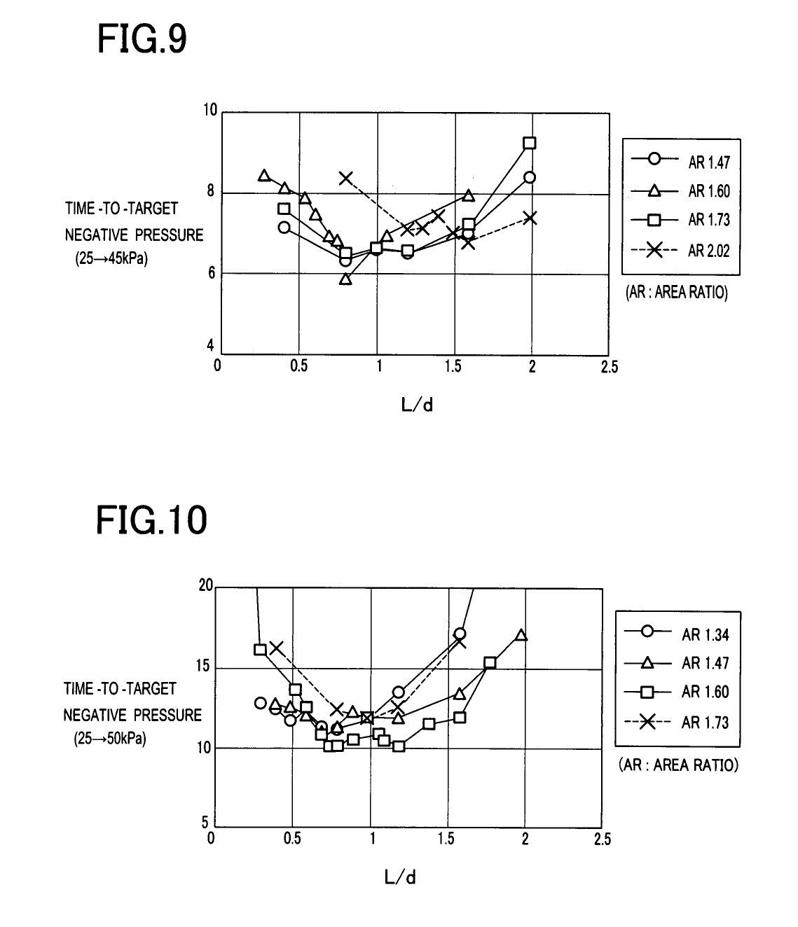

Here, FIGS. 7 to 10 show results of measurement of the time-to-target negative pressure by the ejectors 10 with different L/d ratios to generate the target negative pressure P. FIG. 7 is a graph showing a relation between the L/d ratio and the time-to-target negative pressure for a target negative pressure of 30 kPa; FIG. 8 is a graph showing a relation between the L/d ratio and the time-to-target negative pressure for a target negative pressure of 40 kPa; FIG. 9 is a graph showing a relation between the L/d ratio and the time-to-target negative pressure for a target negative pressure of 45 kPa; and FIG. 10 is a graph showing a relation between the L/d ratio and the time-to-target negative pressure for a target negative pressure of 50 kPa. The “area ratio” in FIGS. 7 to 10 represents the SD/Sd ratio.

FIGS. 7 to 10 reveal that, as the target negative pressure P is higher, the optimum range of the L/d ratio for shortening the time-to-target negative pressure is smaller. Specifically, as can be seen from FIG. 7, the time-to-target negative pressures are little different even though the L/d ratios are different. For the target negative pressure P of about 30 kPa, the L/d ratio is considered to have little influence on the time-to-target negative pressure. On the other hand, as is evident from FIGS. 8 to 10, the time-to-target negative pressures vary depending on the L/d ratios. When the target negative pressure P is larger than 40 kPa, accordingly, it can be considered that the time-to-target negative pressure is shortened by optimization of the L/d ratio.

Hence, the optimum range of the L/d ratio will be studied below referring to FIGS. 8 to 10. Firstly, as shown in FIG. 8, the time-to-target negative pressure is longer in both the cases where the L/d ratio is lower than 0.5 and where the L/d is more than 1.70. Accordingly, for the target negative pressure P of 40 kPa, the L/d ratio has only to be set in a range of 0.5≦L/d≦1.7.

As is evident from FIG. 9, the time-to-target negative pressure is longer when the L/d ratio lower than 0.5 and also the time-to-target negative pressure is extremely longer when the L/d ratio is more than 1.6. For the target negative pressure P of 45 kPa, accordingly, the L/d ratio has only to be set in a range of 0.5≦L/d≦1.6 in order to shorten the time-to-target negative pressure.

Further, as can be seen from FIG. 10, the time-to-target negative pressure is longer when the L/d ratio is lower than 0.5 and also it is extremely longer when the L/d ratio is more than 1.5. For the target negative pressure P of 50 kPa, accordingly, the L/d ratio has only to be set in a range of 0.5≦L/d≦1.5 in order to shorten the time-to-target negative pressure.

The above results show that the ejector 10 with the target negative pressure P in the decompression chamber 16 set in the range of “40 kPa≦P≦50 kPa” has to be designed to have the L/d ratio satisfying the relation of “0.50≦L/d≦1.50”, thereby further shortening the time-to-target negative pressure.

Here, preferably, the L/d ratio is set to satisfy the relation of “0.75≦L/d≦1.20”. By setting the L/d ratio in such a numerical range, the time-to-target negative pressure can be minimized as shown in FIGS. 8 to 10.

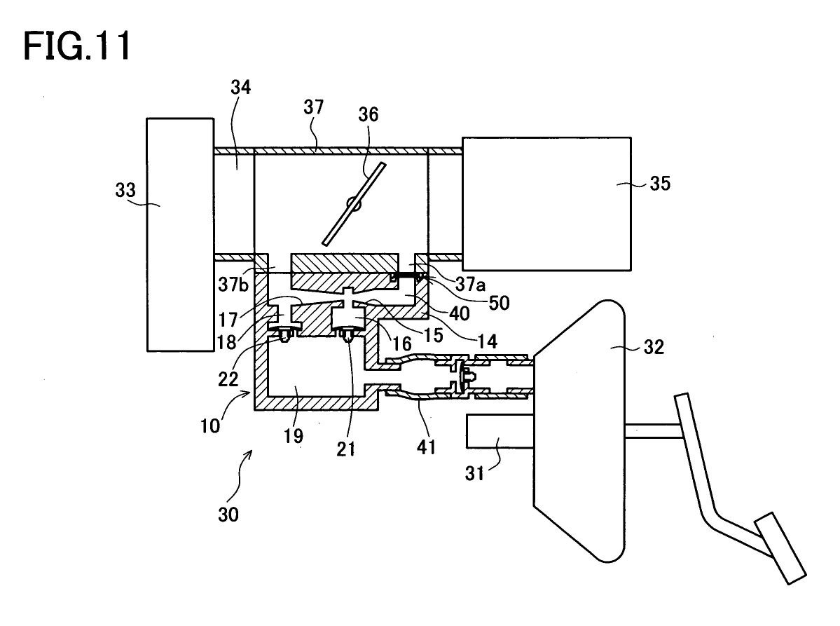

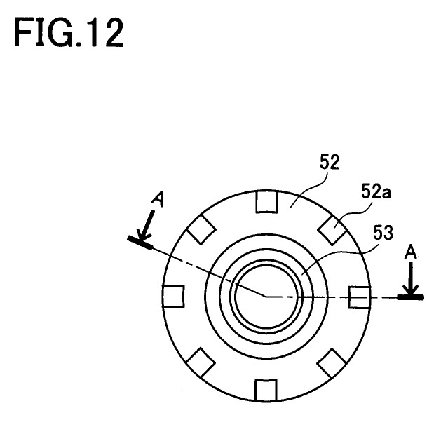

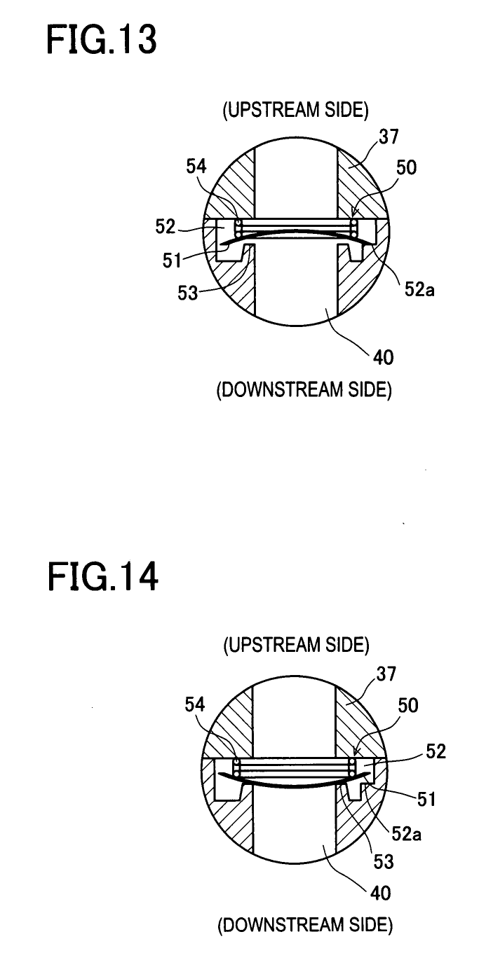

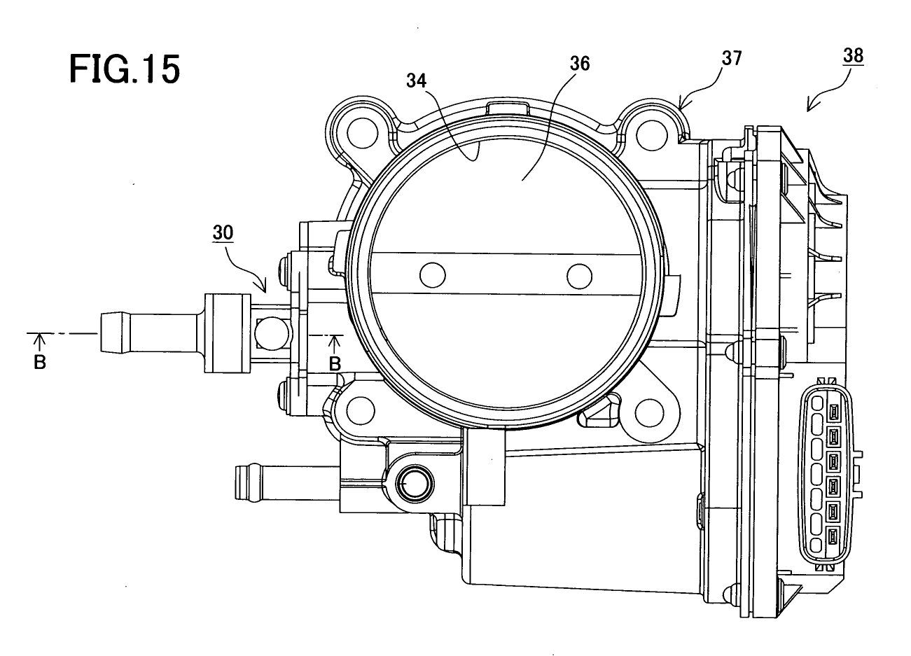

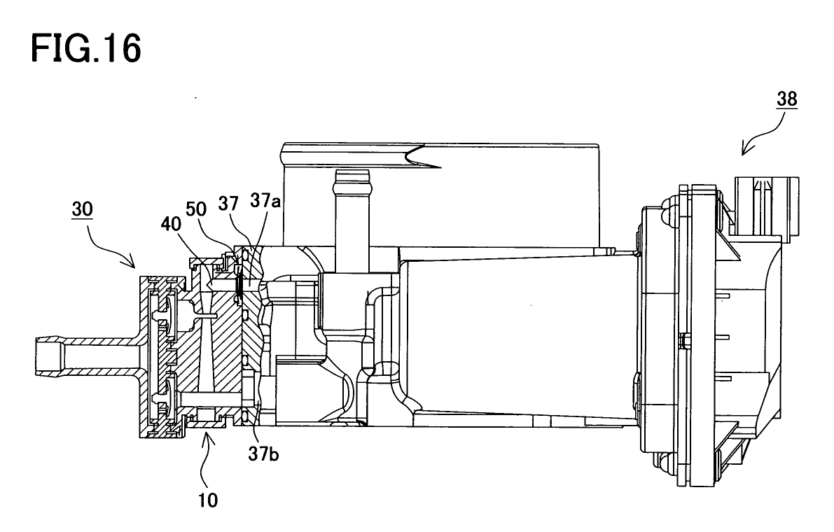

Successively, the negative pressure supply apparatus for brake booster using the ejector 10 mentioned above will be explained referring to FIG. 11. FIG. 11 is a schematic configuration view of the negative pressure supply apparatus for brake booster according to the present embodiment; FIG. 12 is a plan view showing the shape of a valve chamber of an opening and closing valve; FIG. 13 is a sectional view showing a schematic configuration of the opening and closing valve (in a valve-open state) during an engine cold period; FIG. 14 is a sectional view showing a schematic configuration of the opening and closing valve (in a valve-closed state) during an engine warm-up period; FIG. 15 is an external view of a throttle valve control apparatus in which the negative pressure supply apparatus for brake booster is integrally assembled; and FIG. 16 is a partially sectional view of the throttle valve control apparatus of FIG. 15.

A negative pressure supply apparatus for brake booster 30 (hereinafter, simply referred to as a “negative pressure supply apparatus 30”) is arranged to supply a negative pressure (“intake pipe negative pressure”) generated in an intake pipe 34 constituting an air intake system of an engine 33 to a brake booster 32 attached to a brake master cylinder 31 equipped in a vehicle, as shown in FIG. 11. This apparatus 30 is formed with a bypass passage 40 for allowing part of air flowing in the intake pipe 34 to bypass part of the pipe 34 (a throttle valve 36). This bypass passage 40 is formed by the nozzle 15, the diffuser 17, and part of the decompression chamber 16 of the ejector 10. The suction chamber 19 of the ejector 10 communicates with the brake booster 32 through a pipe 41.

Here, the bypass passage 40 is connected to communication passages 37a and 37b formed in a throttle body 37 and communicates with the intake pipe 34. That is, the passage including the bypass passage 40 and communication passages 37a and 37b corresponds to a “bypass passage” of the present invention. An entrance (the communication passage 37a) of the bypass passage 40 is located between an air cleaner 35 fixed to an end of the intake pipe 34 and a throttle valve 36 placed at some position in the intake pipe 34. On the other hand, an exit (the communication passage 37b) of the bypass passage 40 is located between the throttle valve 36 and the engine 33.

Further, an opening and closing valve 50 is placed between an inlet port of the ejector 10 and the communication passage 37a (on the upstream side of the ejector 10) to open and close the bypass passage 40 for executing ON-OFF control of the operation of the ejector 10, thereby making the ejector 10 active or inactive. This opening and closing valve 50 is configured to perform valve opening and closing operations by a temperature sensitive medium. In the present embodiment, a bimetal is used for the temperature sensitive medium.

The opening and closing valve 50 includes a valve chamber 52 having a bottom formed with a plurality of protrusions 52a (eight protrusions in the present embodiment) arranged at predetermined intervals as shown in FIG. 12. In this valve chamber 52, a disc-shaped bimetal 51 serving as a valve element is placed as shown in FIGS. 13 and 14. FIGS. 13 and 14 show sectional views of the opening and closing valve 50 taken along a line A-A in FIG. 12. On the downstream side of the valve chamber 52, a valve seat 53 is formed in an area communicating with the bypass passage 40. The bimetal 51 can be brought into or out of contact with the valve seat 53. A spring 54 is disposed on the opposite side of the bimetal 51 from the valve seat 53. This spring 54 serves to press the outer peripheral edge of the bimetal 51 against the protrusions 52a formed at the predetermined intervals on the bottom of the valve chamber 52, thereby fixedly holding the bimetal 51 in the valve chamber 52.

As shown in FIG. 13, when the bimetal 51 is separate from the valve seat 53, allowing communication between the upstream side and the downstream side of the valve chamber 52 through clearances between the spaced protrusions 52a, the opening and closing valve 50 is placed in a valve opening state. On the other hand, when the bimetal 51 is brought into contact with the valve seat 53 as shown in FIG. 14, interrupting communication between the upstream side and the downstream side of the valve chamber 52, the opening and closing valve 50 is placed in a valve closing state.

The bimetal 51 is configured to become curved in the following manner depending on the temperature in the throttle body 37. Specifically, the bimetal 51 is convex in an upstream direction, separating from the valve seat 53, as shown in FIG. 13 while the temperature in the throttle body 37 is in a range corresponding to the cold period in which the water temperature of the engine 33 is for example 40° C. or less. Also, the bimetal 51 is convex (recurved) in a downstream direction, coming into contact with the valve seat 53, as shown in FIG. 14 while the temperature in the throttle body 37 in a range corresponding to the warm-up period in which the water temperature of the engine 33 is for example more than 40° C. With this bimetal 51, the opening and closing valve 50 allows the bypass passage 40 to open during the cold period of the engine 33 and close during the warm-up period of the engine 33.

Opening and closing of the bypass passage 40 may be conducted by a solenoid valve or a diaphragm valve. However, the aforementioned opening and closing valve 50 is constituted of the bimetal 51 provided in the valve chamber 52 and the spring 54 supporting the bimetal 51, so that this valve 50 is a very simple structure needing only a small number of components as compared with the solenoid valve or diaphragm valve. Accordingly, the opening and closing valve 50 can be small in size and light in weight, and low in manufacturing cost.

As shown in FIG. 15, the negative pressure supply apparatus 30 is assembled in a well known throttle valve control apparatus 38 provided with the throttle body 37 including part of the intake pipe 34 of the engine 33, the throttle valve 36 rotatably supported in the throttle body 37, and a driving mechanism (a motor, a gear, etc.) for driving (opening and closing) the throttle body 36. To be concrete, as shown in FIG. 16, the negative pressure supply apparatus 30 is connected to the throttle body 37 through a sealing member so that the bypass passage 40 is connected to the communication passages 37a and 37b of the throttle body 37. A sectional part in FIG. 16 corresponds to a view taken along a line B-B in FIG. 15.

Since the negative pressure supply apparatus 30 is integrally assembled with the throttle body 37 as mentioned above, the operation of the opening and closing valve 50 can be controlled by heat transmission from a hot-water pipe provided in the throttle body 37. Thus, the opening/closing control of the opening and closing valve 50 can be executed accurately according to the state of the engine 33 (during the cold period or during the warm-up period).

The negative pressure supply apparatus 30 does not have to be placed singly, unlike the conventional apparatus, and therefore needs no fixing tool that would be required for the conventional apparatus. This makes it possible to eliminate the need for a pipe for connecting the negative pressure supply apparatus to the intake pipe. Thus, the negative pressure supply apparatus 30 can be provided with reduced total weight and in lowered cost. Since the need for providing a pipe to the negative pressure supply apparatus 30 is eliminated, achieving shortening of the length of the bypass passage 40 and accordingly lowering pressure loss, the performance of the negative pressure supply apparatus 30 can be enhanced.

The following explanation is made on the operation of the negative pressure supply apparatus 30 configured as above. During the cold period of the engine 33, firstly, the bimetal 51 placed in the opening and closing valve 50 is held in a convex shape protruding in the upstream direction, separating from the valve seat 53, thereby allowing the bypass passage 40 to open. Hence, the air flowing from the air cleaner 35 into the intake pipe 34 toward the throttle valve 36 is partly allowed to pass through the bypass passage 40 and flow into part of the intake pipe 34 downstream from the throttle valve 36. The ejector 10 is thus made active, increasing an intake pipe negative pressure.

At this time, the increased intake pipe negative pressure acts on the first check valve 21 to open the valve 21. The increased intake pipe negative pressure is therefore supplied from the decompression chamber 16, via the suction chamber 19 and the pipe 41, to the brake booster 32. The ejector 10 can generate the target negative pressure P in a short operating time, thereby supplying the increased negative pressure to the brake booster 32 with good response.

As mentioned above, the negative pressure supply apparatus 30 can supply the increased intake pipe negative pressure to the brake booster 32 during the engine cold period. Consequently, even where the intake pipe negative pressure is low because of delaying of an ignition timing during the cold period for inducing activation of a catalyst, it is possible to supply, with good response (rapidly), an intake pipe negative pressure sufficient to activate the brake booster 32.

During the warm-up period, the bimetal 51 provided in the opening and closing valve 50 is recurved to be convex in the downstream direction, coming into contact with the valve seat 53. Thus, the opening and closing valve 50 closes off the bypass passage 40. As a result, the air flowing from the air cleaner 35 into the intake pipe 34 toward the throttle valve 36 is checked, or prevented from flowing in the bypass passage 40. The ejector 10 is made inactive. At this time, the intake pipe negative pressure acts on the second check valve 22 to open the second check valve 22. The intake pipe negative pressure is accordingly supplied directly to the brake booster 32 via the suction chamber 19 and the pipe 41. Consequently, an excess amount of air flow to the engine 33 in the warm-up state can be prevented, thereby avoiding a decrease in accuracy of air flow control in the control of fuel-air ratio of the engine 33.

As described above, the ejector 10 of the present embodiment is arranged such that the SD/Sd ratio between the inlet sectional area SD of the diffuser 17 and the outlet sectional area Sd of the nozzle 15 is set in the range of “1.20≦SD/Sd≦4.08−0.047P”. Accordingly, even where the target negative pressure P in the decompression chamber 16 is as large (high) as a value set in a range of “40 kPa<P≦50 kPa”, the target negative pressure P can be obtained in a short operating time. The ejector 10 is also configured such that the L/d ratio of the distance L between the outlet of the nozzle 15 and the inlet of the diffuser 17 with respect to the outlet diameter d of the nozzle 15 is set in the range of “0.50≦L/d≦1.50”, so that the time-to-target negative pressure can further be shortened.

According to the negative pressure supply apparatus 30 for brake booster using the above ejector 10, during the cold period of the engine 33, the ejector 10 can be made active to increase the intake pipe negative pressure to the target negative pressure in a short time and supply such an increased negative pressure to the brake booster 32. During the warm-up time of the engine 33, on the other hand, the ejector 10 can be made inactive, checking the excess air flow to the engine 33, thereby preventing a decrease in accuracy of air flow control in the control of fuel-air ratio of the engine 33.

The aforementioned embodiment is merely an example, and the present invention may be embodied in other specific forms without departing from the essential characteristics thereof.

What is claimed is:

1. An ejector for generating a negative pressure, including:
a nozzle communicating with a fluid inlet;
a diffuser communicating with a fluid outlet; and
a decompression chamber placed between the nozzle and the diffuser;
wherein the ejector is arranged to generate the negative pressure in the decompression chamber by a fluid ejected from the nozzle,
a target pressure P in the decompression chamber is set in a range of “40 kPa<P≦50 kPa”, and an SD/Sd ratio between a sectional area SD of an inlet of the diffuser and a sectional area Sd of an outlet of the nozzle is determined to satisfy a relation:
“1.20≦SD/Sd≦4.08−0.047P”.

2. The ejector according to claim 1, wherein
an L/d ratio of a distance L between the outlet of the nozzle and the inlet of the diffuser to a diameter d of the outlet of the nozzle is determined to satisfy a relation:
“0.50≦L/d≦1.50”.

3. The ejector according to claim 1, wherein
an L/d ratio of a distance L between the outlet of the nozzle and the inlet of the diffuser to a diameter d of the outlet of the nozzle is determined to satisfy a relation:
“0.75≦L/d≦1.20”.

4. A negative pressure supply apparatus for brake booster for supplying a negative pressure to a brake booster mounted in a vehicle,
wherein the supply apparatus includes the ejector according to claim 1, and
the decompression chamber can be communicated with the brake booster.

5. The negative pressure supply apparatus for brake booster according to claim 4, wherein
the negative pressure supply apparatus further includes a bypass passage for allowing part of air flowing in an intake pipe to bypass part of the intake pipe,
the ejector is placed in the bypass passage, and
the negative pressure supply apparatus includes an opening and closing device placed upstream from the ejector and operated to open and close the bypass passage.

6. The negative pressure supply apparatus for brake booster according to claim 5, wherein the opening and closing device is a valve using a temperature sensitive medium.

7. An ejector for generating a negative pressure, including:
a nozzle communicating with a fluid inlet;
a diffuser communicating with a fluid outlet; and
a decompression chamber placed between the nozzle and the diffuser;
wherein the ejector is arranged to generate the negative pressure in the decompression chamber by a fluid ejected from the nozzle,
a target pressure P in the decompression chamber is set in a range of “40 kPa<P≦50 kPa”, and
a SD/Sd ratio between a sectional area SD of an inlet of the diffuser and a sectional area Sd of an outlet of the nozzle is determined to satisfy a relation:
“1.25≦SD/Sd≦4.2−0.05P”.

8. The ejector according to claim 7, wherein
an L/d ratio of a distance L between the outlet of the nozzle and the inlet of the diffuser to a diameter d of the outlet of the nozzle is determined to satisfy a relation:
“0.50≦L/d≦1.50”.

9. The ejector according to claim 7, wherein
an L/d ratio of a distance L between the outlet of the nozzle and the inlet of the diffuser to a diameter d of the outlet of the nozzle is determined to satisfy a relation:
“0.75≦L/d≦1.20”.

10. A negative pressure supply apparatus for brake booster for supplying a negative pressure to a brake booster mounted in a vehicle,
wherein the supply apparatus includes the ejector according to claim 7, and
the decompression chamber can be communicated with the brake booster.

11. The negative pressure supply apparatus for brake booster according to claim 10, wherein
the negative pressure supply apparatus further includes a bypass passage for allowing part of air flowing in an intake pipe to bypass part of the intake pipe,
the ejector is placed in the bypass passage, and
the negative pressure supply apparatus includes an opening and closing device placed upstream from the ejector and operated to open and close the bypass passage.

12. The negative pressure supply apparatus for brake booster according to claim 11, wherein the opening and closing device is a valve using a temperature sensitive medium.

13. An ejector for generating a negative pressure, including:
a nozzle communicating with a fluid inlet;
a diffuser communicating with a fluid outlet; and
a decompression chamber placed between the nozzle and the diffuser;
wherein the ejector is arranged to generate the negative pressure in the decompression chamber by a fluid ejected from the nozzle,
a target pressure P in the decompression chamber is set to 40 kPa or lower, and
a SD/Sd ratio between a sectional area SD of an inlet of the diffuser and a sectional area Sd of an outlet of the nozzle is determined to satisfy a relation:
“1.25≦SD/Sd≦2.2”.

14. A negative pressure supply apparatus for brake booster for supplying a negative pressure to a brake booster mounted in a vehicle,
wherein the supply apparatus includes the ejector according to claim 13, and
the decompression chamber can be communicated with the brake booster.

15. The negative pressure supply apparatus for brake booster according to claim 14, wherein
the negative pressure supply apparatus further includes a bypass passage for allowing part of air flowing in an intake pipe to bypass part of the intake pipe,
the ejector is placed in the bypass passage, and the negative pressure supply apparatus includes an opening and closing device placed upstream from the ejector and operated to open and close the bypass passage.

16. The negative pressure supply apparatus for brake booster according to claim 15, wherein the opening and closing device is a valve using a temperature sensitive medium.
